(19) United States
(12) Patent Application Publication
(10) Pub. No.: US 2008/0055606 A1
(43) Pub. Date: Mar. 6, 2008

(54) APPARATUS AND METHOD FOR INSPECTING A PATTERN AND METHOD FOR MANUFACTURING A SEMICONDUCTOR DEVICE

(75) Inventors: Hiromu Inoue, Kanagawa-ken (JP); Tomohide Watanabe, Kanagawa-ken (JP); Ryoji Yoshikawa, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/771,456

(22) Filed: Jun. 29, 2007

(30) Foreign Application Priority Data
Jun. 30, 2006 (JP) 2006-182547

(51) Int. Cl. G01B 9/02

(52) U.S. Cl. 356/491; 356/521

(57) ABSTRACT

An apparatus for inspecting a pattern, including: at least one of a first floodlight system for inspection by transmissive light and a second floodlight system for inspection by reflective light; an inspection optical system for capturing an image of the pattern on an object under inspection; and a stage for mounting and moving the object under inspection. The one of the first floodlight system and the second floodlight system includes a diffracted light control means for enhancing light diffracted by the pattern.

### CROSS-REFERENCE TO RELATED APPLICATIONS

This application is based upon and claims the benefit of priority from the prior Japanese Patent Application No. 2006-182547, filed on Jun. 30, 2006; the entire contents of which are incorporated herein by reference.

### BACKGROUND OF THE INVENTION

1. Field of the Invention

This invention relates to an apparatus and method for inspecting a pattern used in manufacturing semiconductor devices and liquid crystal display devices, and to a method for manufacturing a semiconductor device.

2. Background Art

In currently manufactured semiconductor devices, the elements and interconnects constituting a circuit are highly integrated, and their patterns are downscaled. Any defects in the mask serving as an original for patterning semiconductor devices under such high integration and downscaling lead to defective products because the pattern is not accurately projected on the substrate (wafer). Hence defect inspection for inspecting mask defects is needed.

In a conventional technique for such mask defect inspection, an optical image of the pattern enlarged by an optical system is formed on a CCD (charge coupled device) sensor, and the optical image data thus obtained is converted to electrical image data for defect inspection (see, e.g., JP 7-128250A (1995)).

However, the pattern of semiconductor devices of the so-called 55-nm generation has a line width of about 220 nm (nanometers), which is not more than the wavelength of inspection light used for mask defect inspection, 257 nm (nanometers). When the dimension of the object under inspection such as the pattern line width is not more than the wavelength of inspection light in this manner, lack of optical resolution disadvantageously results in insufficient output of defect signals. Then, in the conventional technique as disclosed in JP 7-128250A, there is a problem of insufficient inspection performance. In this respect, the wavelength of inspection light could be decreased to not more than the dimension of the object under inspection. However, this approach involves serious difficulty in designing the optical system because of the radical change of optical conditions.

### SUMMARY OF THE INVENTION

According to an aspect of the invention, there is provided an apparatus for inspecting a pattern, including: at least one of a first floodlight system for inspection by transmissive light and a second floodlight system for inspection by reflective light; an inspection optical system for capturing an image of the pattern on an object under inspection; and a stage for mounting and moving the object under inspection, the one of the first floodlight system and the second floodlight system including a diffracted light control means for enhancing light diffracted by the pattern.

According to another aspect of the invention, there is provided a method for inspecting a pattern by capturing an image of the pattern on an object under inspection, the method including: performing inspection by setting an irradiation condition of the diffracted light control means so as to enhance light diffracted by the pattern.

According to another aspect of the invention, there is provided a method for manufacturing a semiconductor device, including: forming a pattern on a substrate surface; and inspecting the pattern using the method for inspecting the pattern by capturing an image of the pattern, the method including: performing inspection by setting an irradiation condition of the diffracted light control means so as to enhance light diffracted by the pattern.

### BRIEF DESCRIPTION OF THE DRAWINGS

FIG. 1 is a configurational diagram for illustrating an inspection apparatus according to a first embodiment of the invention.

FIG. 2 is a schematic diagram for illustrating the function of a quarter-wavelength plate.

FIG. 3 is a schematic diagram for specifically illustrating the operation of a phase difference plate.

FIG. 4 is a schematic diagram for illustrating the effect of varying the azimuthal angle of the polarization plane of linearly polarized light.

FIG. 5 is a configurational diagram for illustrating an inspection apparatus according to a second embodiment of the invention.

FIG. 6 is a schematic diagram for specifically illustrating the operation of a diaphragm.

FIG. 7 is a schematic diagram for illustrating the effect of a diaphragm.

FIG. 8 is a schematic enlarged diagram of an object under inspection in the vicinity of the inspection surface.

FIG. 9 is a schematic diagram for illustrating inspection where an optimal irradiation condition is specified for each inspection area.

FIG. 10 is a flow chart for illustrating the inspection procedure.

FIG. 11 is a schematic diagram for illustrating the method of matching inspection data.

### DETAILED DESCRIPTION OF THE INVENTION

As a result of investigation, the inventor recognized that, even if the dimension of an object under inspection is not more than the wavelength of inspection light, high-resolution inspection can be performed by enhancing light diffracted by a pattern on the object under inspection.

First, a first embodiment of the invention is described with reference to the drawings. This embodiment illustrates a phase difference plate as a means for enhancing light diffracted by a pattern on the object under inspection (diffracted light control means).

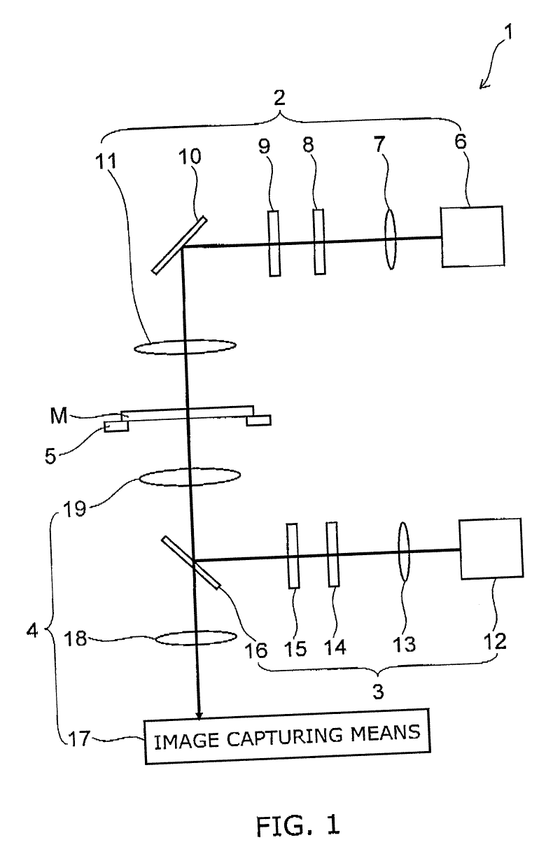

FIG. 1 is a configurational diagram for illustrating an inspection apparatus according to a first embodiment of the invention.

The inspection apparatus 1 shown in FIG. 1 includes a first floodlight system 2 for inspection by transmissive light, a second floodlight system 3 for inspection by reflective light, an inspection optical system 4 for capturing an image of a pattern on an object under inspection M, and a stage 5 for mounting and moving the object under inspection M. For convenience of illustration, a description is given of the inspection apparatus 1 capable of both inspection by transmissive light and inspection by reflective light. However, the inspection apparatus 1 is not limited thereto, but may be capable of only one of the inspections. The first floodlight system 2 includes a transmissive light source 6. Along the optical path of the transmissive light source 6 are provided a collector lens 7, a phase difference plate 8, a phase difference plate 9, a mirror 10, and a condenser lens 11. Here, the mirror 10 is not necessarily needed, but the transmissive light source 6, the collector lens 7, the phase difference plate 8, the phase difference plate 9, and the condenser lens 11 may be arranged in line.

The second floodlight system 3 includes a reflective light source 12. Along the optical path of the reflective light source 12 are provided a collector lens 13, a phase difference plate 14, a phase difference plate 15, and a half mirror 16.

The transmissive light from the first floodlight system 2 and the reflective light from the second floodlight system 3 are configured to be incident on an image capturing means 17 with their optical paths being generally in agreement with each other. Along the optical path are provided an imaging lens 18 and an objective lens 19, which constitute the inspection optical system 4 in conjunction with the image capturing means 17.

The transmissive light source 6 and the reflective light source 12 preferably emit short-wavelength light. For example, it is possible to use a YAG laser source having a wavelength of 266 nm (nanometers) and a deep-ultraviolet solid-state laser source having a wavelength of 257 nm (nanometers).

The image capturing means 17 converts optical image data to electrical image data, and can illustratively be a CCD (charge coupled device) sensor.

The object under inspection M can illustratively be a reticle or other photomask, as well as a substrate (wafer), and a glass substrate for a liquid crystal display device, but is not limited thereto.

The phase difference plates 8, 9, 14, and 15 serve for conversion between linear and circular polarization and for varying the azimuthal angle of the polarization plane of linearly polarized light. Here the phase difference plates 8 and 14 are half-wavelength plates for varying the azimuthal angle of the polarization plane of linearly polarized light. The phase difference plates 9 and 15 are quarter-wavelength plates for conversion among linear, circular, and elliptic polarization. The phase difference plates 8, 9, 14, and 15 can be rotated by a rotation means, not shown, with the optical path serving as a rotation axis. Hence, by rotating and positioning these phase difference plates, it is possible to provide conversion between linear and circular polarization and to vary the azimuthal angle of the polarization plane of linearly polarized light.

The function of the phase difference plate is briefly described by taking a quarter-wavelength plate as an example.

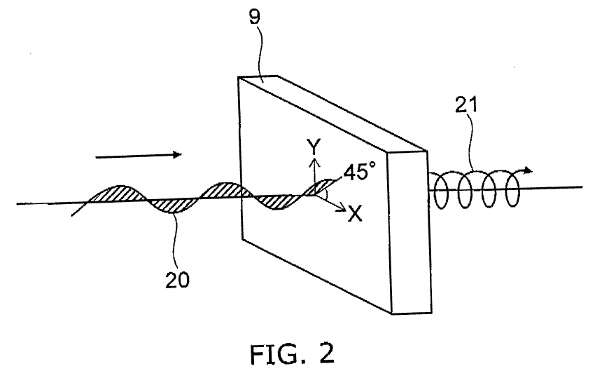

FIG. 2 is a schematic diagram for illustrating the function of a quarter-wavelength plate.

Assume that in the XY plane shown in FIG. 2, linearly polarized light 20 oscillating in a direction inclined 45 degrees from the X-axis is perpendicularly incident on the phase difference plate 9. The incident linearly polarized light 20 can be considered as two orthogonal linearly polarized lights. Because of the incidence inclined 45 degrees from the X-axis in the XY plane, the component oscillating along the X-axis has the same amplitude as the component oscillating along the Y-axis. If the refractive index is different between the X-axis and Y-axis direction, the component transmitted through the higher refractive index portion has a larger optical path length and produces a phase difference of a quarter wavelength (n/2) after being transmitted. Here, because the component oscillating along the X-axis has the same amplitude as the component oscillating along the Y-axis, the oscillation of light draws a circular trajectory in the XY plane, resulting in circularly polarized light 21. On the contrary, incidence of circularly polarized light 21 results in linearly polarized light 20 oscillating in a direction inclined 45 degrees from the X-axis in the XY plane. By varying the inclination (azimuthal angle) of linearly polarized light 20 from the X-axis, elliptically or linearly polarized light can also be obtained. Here the ellipticity of elliptically polarized light depends on the inclination of linearly polarized light 20 from the X-axis. The foregoing also applies to a half-wavelength plate, except that it produces a phase difference of a half wavelength (n) after being transmitted. Hence the half-wavelength plate is used for varying the azimuthal angle of the polarization plane of linearly polarized light.

The phase difference plate can illustratively be a pressurized resin sheet where the photoelastic effect of residual strain due to the applied pressure is used to produce a phase difference, and a quartz or other birefringent crystal where its thickness is adjusted to produce a phase difference.

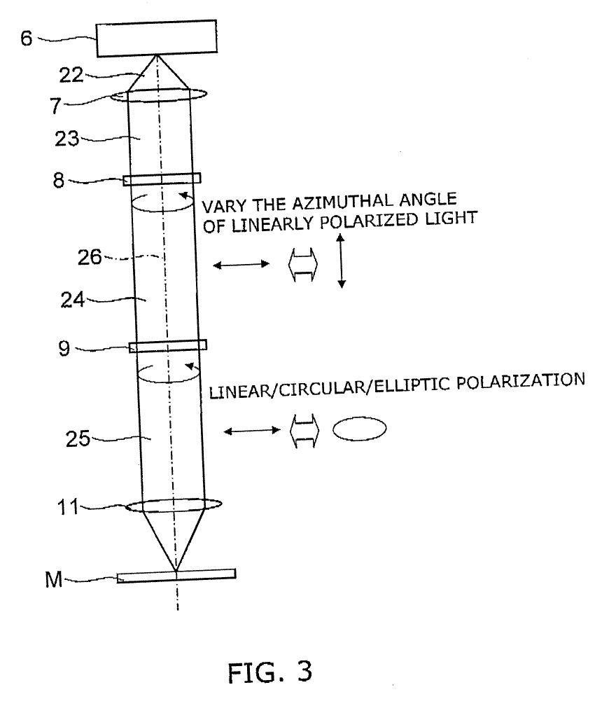

FIG. 3 is a schematic diagram for specifically illustrating the operation of a phase difference plate. Elements similar to those in FIG. 1 are marked with like reference numerals and are not described. Linearly polarized light 22 is emitted from the transmissive light source 6 such as a deep-ultraviolet solid-state laser source and collected by the collector lens 7 to form linearly polarized light 23, which is incident on the phase difference plate 8, a half-wavelength plate. The phase difference plate 8 can be rotated by a rotation means, not shown, with the optical path axis 26 serving as a rotation axis to vary the azimuthal angle of the polarization plane of the resulting linearly polarized light 24. This linearly polarized light 24 is incident on the phase difference plate 9, a quarter-wavelength plate. The phase difference plate 9 can be rotated by a rotation means, not shown, with the optical path axis 26 serving as a rotation axis to convert the linearly polarized light 24 to polarized light 25. Here, linear, circular, or elliptic polarization can be selected by the azimuthal angle of the linearly polarized light 24. The ellipticity of elliptically polarized light can also be selected. The polarized light 25 is incident on the condenser lens 11, and then applied to the inspection surface of the object under inspection M. Thus, by adjusting the phase difference plates, the azimuthal angle of the polarization plane of linearly polarized light can be varied, and linearly polarized light can be converted to linearly, circularly, or elliptically polarized light. The object under inspection M can be irradiated with the resulting light.

Next, a description is given of the effect of irradiating the object under inspection M while varying the azimuthal angle of the polarization plane of linearly polarized light and/or converting linearly polarized light to circularly polarized light.

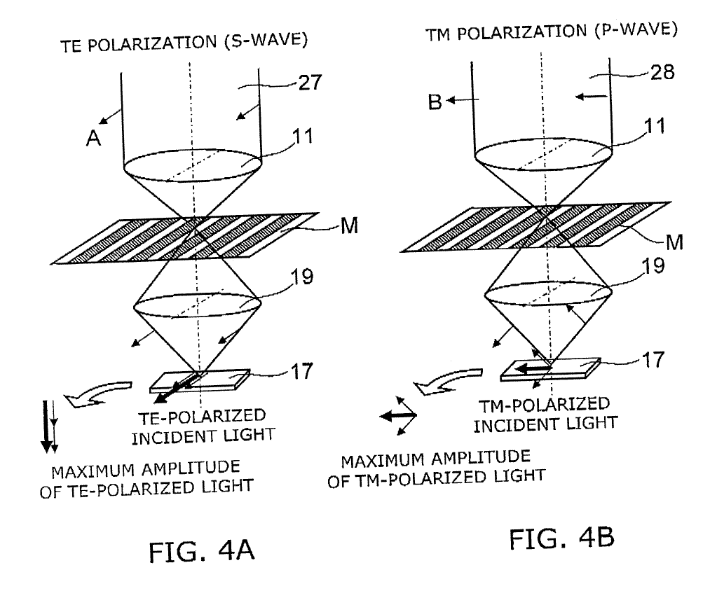

FIG. 4 is a schematic diagram for illustrating the effect of varying the azimuthal angle of the polarization plane of linearly polarized light. FIG. 4A shows the case where incident light 27 is TE-polarized (transverse electric wave, S-wave). For TE polarization, the oscillating direction of the electric field of the incident light is perpendicular to the page (the direction indicated by arrow A in the figure). The maximum amplitude is doubled due to constructive interference of light diffracted by the pattern of the inspection surface of the object under inspection M. This is schematically represented by the lower-left figure of arrows in FIG. 4A.

FIG. 4B shows the case where incident light is TM-polarized (transverse magnetic wave, P-wave). For TM polarization, the oscillating direction of the electric field of the incident light 28 is parallel to the page (the direction indicated by arrow B in the figure). The vertical components (vertical in the page) of light diffracted by the pattern of the inspection surface of the object under inspection M have opposite directions and cancel each other out. Hence constructive interference of only horizontal components contributes to the maximum amplitude. This is schematically represented by the lower-left figure of arrows in FIG. 4B.

Hence the contrast of an image formed by TM-polarized light (P-wave) on the image capturing means 17 is lower than the contrast of an image formed by TE-polarized light (S-wave), and has a decreased resolution accordingly. This means that, if the pattern on the inspection surface of the object under inspection M has a particular direction, it is possible to enhance the diffracted light and to improve optical intensity by matching the azimuthal angle of the polarization plane of linearly polarized light with the direction of the pattern.

Thus, in inspection, when the pattern on the object under measurement M has a particular direction, it is possible to enhance the diffracted light and to perform high-resolution inspection by matching the azimuthal angle of the polarization plane of linearly polarized light with the direction of the pattern. When the pattern has no particular direction, sufficient resolution independent of the direction of the pattern can be ensured by performing inspection with circularly polarized light.

Next, returning to FIG. 1, the operation of the inspection apparatus 1 is described.

The linearly polarized light emitted from the transmissive light source 6 is collected by the collector lens 7, travels through the phase difference plates 8 and 9, and is incident on the mirror 10. Here, taking into consideration the directionality of the pattern on the object under inspection M as described above, the type and azimuthal angle of polarized light applied to the object under inspection M are appropriately selected. This selection is performed by a rotation means, not shown, which rotates the phase difference plates 8 and 9 with the optical path serving as a rotation axis. The light incident on the mirror 10 is diverted downward at right angle, is incident on the condenser lens 11, and is applied to the inspection surface of the object under inspection M. The image obtained by the transmission of this light through the inspection surface of the object under inspection M is enlarged by the objective lens 19, then travels through the half mirror 16, and is imaged by the imaging lens 18 on the image capturing means 17. The optical image data thus obtained is converted to electrical image data by the image capturing means 17 and sent to an image processing means, not shown, which determines the presence and size of defects to check the quality of the object. When the inspection of one site is completed, the object under inspection M is moved to the next inspection site by the stage 5, and inspection is continued.

The light emitted from the reflective light source 12 is collected by the collector lens 13, travels through the phase difference plates 14 and 15, and is incident on the half mirror 16. The light incident on the half mirror 16 is diverted upward at right angle, is incident on the objective lens 19, and is applied to the inspection surface of the object under inspection M. The image obtained by the reflection of this light at the inspection surface of the object under inspection M is enlarged by the objective lens 19, then travels through the half mirror 16, and is imaged by the imaging lens 18 on the image capturing means 17. The operation of the phase difference plates 14 and 15, the conversion from optical image data to electrical image data, and the movement of the object under inspection M by the stage 5 are the same as those described above.

Thus inspection by transmissive light and inspection by reflective light are performed. Here, even if the dimension of the object under inspection is not more than the wavelength of inspection light and the resolution is decreased, the diffracted light can be enhanced by taking into consideration the directionality of the pattern on the object under inspection M, and hence high-resolution inspection can be performed.

Next, a second embodiment of the invention is described with reference to the drawings.

This embodiment illustrates a diaphragm as a means for enhancing light diffracted by a pattern on the object under inspection (diffracted light control means).

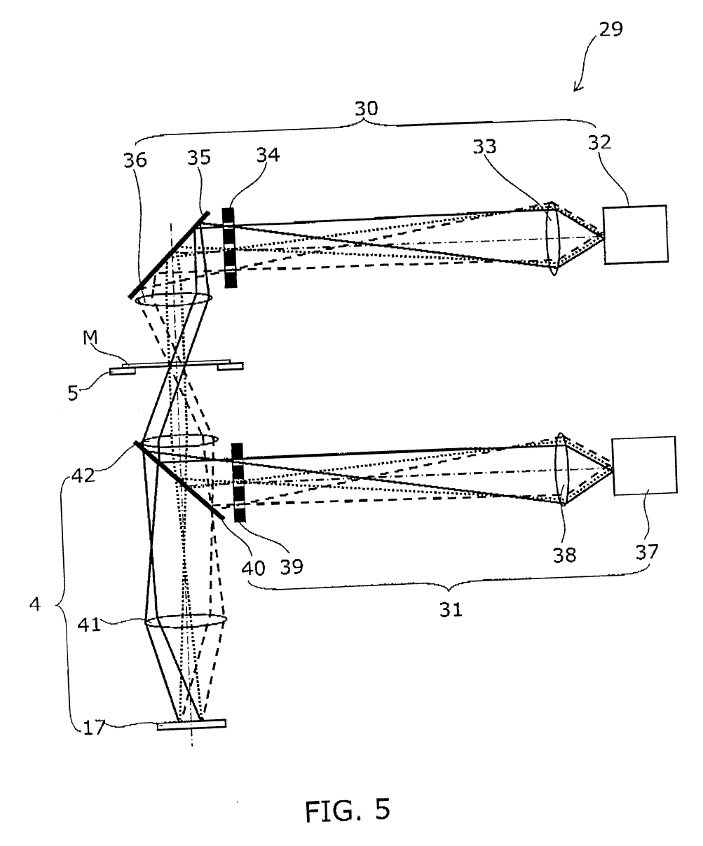

FIG. 5 is a configurational diagram for illustrating an inspection apparatus according to a second embodiment of the invention.

The inspection apparatus 29 shown in FIG. 5 includes a first floodlight system 30 for inspection by transmissive light, a second floodlight system 31 for inspection by reflective light, an inspection optical system 4 for capturing an image of an object under inspection M, and a stage 5 for mounting and moving the object under inspection M. For convenience of illustration, a description is given of the inspection apparatus 29 capable of both inspection by transmissive light and inspection by reflective light. However, the inspection apparatus 29 is not limited thereto, but may be capable of only one of the inspections.

The first floodlight system 30 includes a transmissive light source 32. Along the optical path of the transmissive light source 32 are provided a collector lens 33, a diaphragm 34, a mirror 35, and a condenser lens 36. Here, the mirror 35 is not necessarily needed, but the transmissive light source 32, the collector lens 33, the diaphragm 34, and the condenser lens 36 may be arranged in line.

The second floodlight system 31 includes a reflective light source 37. Along the optical path of the reflective light source 37 are provided a collector lens 38, a diaphragm 39, and a half mirror 40.

The transmissive light from the first floodlight system 30 and the reflective light from the second floodlight system 31 are configured to be incident on an image capturing means 17 with their optical paths being generally in agreement with each other. Along the optical path are provided an imaging lens 41 and an objective lens 42, which constitute the inspection optical system 32 in conjunction with the image capturing means 17.

The transmissive light source 32 and the reflective light source 37 preferably emit short-wavelength light. For example, it is possible to use a YAG laser source having a wavelength of 266 nm (nanometers) and a deep-ultraviolet solid-state laser source having a wavelength of 257 nm (nanometers).

The image capturing means 17 converts optical image data to electrical image data, and can illustratively be a CCD (charge coupled device) sensor.

The object under inspection M can illustratively be a reticle or other photomask, as well as a substrate (wafer), and a glass substrate for a liquid crystal display device, but is not limited thereto.

The diaphragms 34 and 39 serve to transmit a particular portion of light so that the inspection surface of the object under inspection M is irradiated therewith, and are located at a position conjugate to the pupil plane of the objective lens 42. The position and area of the opening thereof can be adjusted by an adjustment means, not shown. By adjusting the position and area of the opening using the adjustment means, a particular portion of light can be transmitted so that the inspection surface of the object under inspection M is irradiated therewith. Alternatively, it is possible to prepare a number of diaphragms having a different position and/or area of opening for automatic or manual replacement.

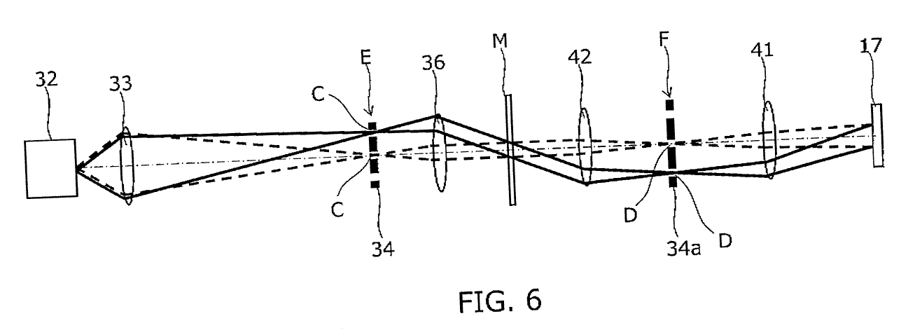

FIG. 6 is a schematic diagram for specifically illustrating the operation of a diaphragm. Elements similar to those in FIG. 5 are marked with like reference numerals and are not described. Light is emitted from the transmissive light source 32 such as a deep-ultraviolet solid-state laser source and collected by the collector lens 33 at the rear focal position C of the condenser lens 36 to form a parallel light flux, which is applied to the inspection surface of the object under inspection M. The parallel light flux transmitted through the inspection surface is incident on the objective lens 42 and travels through the objective lens 42 and the imaging lens 41. Thus an image of the inspection surface is formed on the image capturing means 17.

Here, if a diaphragm 34 is placed at a position E conjugate to the pupil plane of the objective lens 42 (the rear focal position D of the objective lens) to transmit a particular portion of light so that the inspection surface of the object under inspection M is irradiated therewith, then only a light flux making a particular angle with the inspection surface can be transmitted. Also if a diaphragm 34a is placed at the pupil plane F of the objective lens 42 (the rear focal position D of the objective lens) to transmit a particular portion of light with which the inspection surface of the object under inspection M has been irradiated, then only a light flux making a particular angle with the inspection surface can be transmitted. By using this configuration, only a light flux making a particular angle with the inspection surface of the object under inspection M can be imaged on the image capturing means 17. For convenience of illustration, FIG. 6 shows diaphragms 34 and 34a at the pupil plane F of the objective lens 42 and its conjugate position E. However, the diaphragm only needs to be placed at least one of these positions.

Next, the effect of the diaphragm is described.

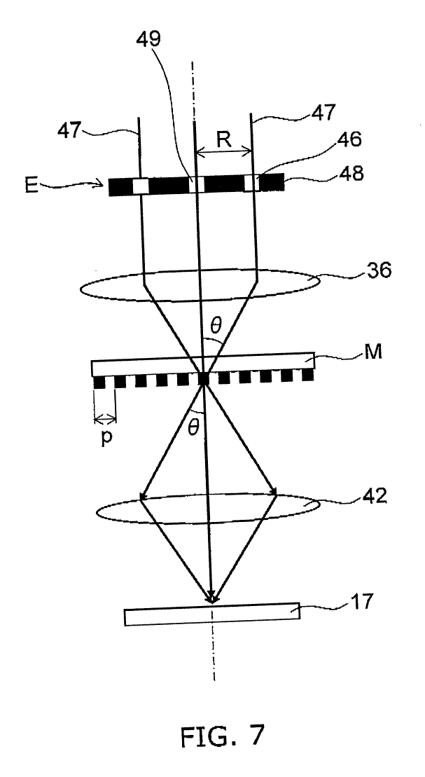

FIG. 7 is a schematic diagram for illustrating the effect of a diaphragm.

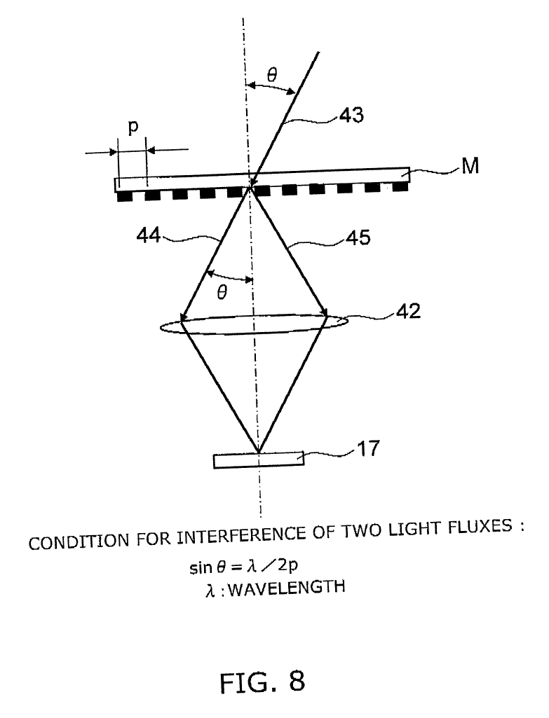

FIG. 8 is a schematic enlarged diagram of an object under inspection in the vicinity of the inspection surface.

Elements similar to those in FIG. 6 are marked with like reference numerals and are not described.

As shown in FIG. 7, by placing a diaphragm 48 at a position E conjugate to the pupil plane of the objective lens 42 to transmit a particular portion of light, the pattern on the inspection surface of the object under inspection M can be irradiated with the light at a particular angle. Here, by appropriately setting the irradiation angle, the light diffracted by the pattern on the inspection surface can be collected. If the diffracted light can be collected, the amount of captured light can be increased, and background light not contributing to the contrast can be blocked. Hence the resolution can be improved.

As shown in FIG. 8, the condition for interference of two light fluxes produced from the irradiation light 43 is that the zeroth order diffracted light 44 and the first order diffracted light 45 have the same diffraction angle θ, given by sin θ=λ/(2×p), where λ is the wavelength of the irradiation light and p is the pitch of the pattern.

Therefore, if a diaphragm 48 achieving the same diffraction angle θ is placed at the position E conjugate to the pupil plane of the objective lens 42, the zeroth order diffracted light 44 and the first order diffracted light 45 diffracted by the pattern on the inspection surface can be collected. In general, the angle of irradiation light for collecting the N-th order diffracted light satisfies sine=N×ζ/(2×p). Hence, by placing a diaphragm 48 satisfying this condition at the position E conjugate to the pupil plane of the objective lens 42, the N-th order diffracted light can be collected.

Here, if a diaphragm 48 having an annular opening 46 is used, the radius R of the opening 46 is equal to the σ value of incident light 47 (ratio of the numerical aperture of the transmissive light source 32 to the numerical aperture NA of the objective lens 42), and can be calculated by the following formula:
R=σ=sin θ/NA=N×λ/(NA×2×p)

Thus, by placing a diaphragm 48 at the pupil plane F of the objective lens 42 or at its conjugate position E to transmit a particular portion of light, a larger amount of light diffracted by the pattern on the inspection surface can be collected, and background light not contributing to the contrast can be blocked. Hence optical resolution in imaging the pattern having a periodic pitch p can be improved.

The diaphragm 48 illustrated in FIG. 7 serves to increase optical resolution by using an annular opening 46 to collect the diffracted light at the objective lens, and has another opening 49 also at the center to collect also the diffracted light from patterns having different pitches p. Hence high resolution can be also achieved for patterns having various pitch dimensions and configurations.

Next, returning to FIG. 5, the operation of the inspection apparatus 29 is described.

The light emitted from the transmissive light source 32 is collected by the collector lens 33, travels through the diaphragm 34, and is incident on the mirror 35. Here, taking into consideration the pitch of the pattern on the object under inspection M as described above, the position and area of the opening of the diaphragm 34 are appropriately selected. This selection is performed by a diaphragm adjustment means, not shown, which varies the position and area of the opening of the diaphragm 34. For example, when a diaphragm 34 having an annular opening is used, a plate-like member, not shown, can be slid on the surface of the diaphragm 34 to vary the radius and area of the opening. Alternatively, it is possible to prepare a number of diaphragms having a different radius and area of opening for automatic or manual replacement. The light incident on the mirror 36 is diverted downward at right angle, is incident on the condenser lens 36, and is applied to the pattern on the inspection surface of the object under inspection M at a particular angle by the effect of the diaphragm 34. The image obtained by the transmission of this light through the inspection surface of the object under inspection M is enlarged by the objective lens 42, then travels through the half mirror 40, and is imaged by the imaging lens 41 on the image capturing means 17. The optical image data thus obtained is converted to electrical image data by the image capturing means 17 and sent to an image processing means, not shown, which determines the presence and size of defects to check the quality of the object. When the inspection of one site is completed, the object under inspection M is moved to the next inspection site by the stage 5, and inspection is continued.

The light emitted from the reflective light source 37 is collected by the collector lens 38, travels through the diaphragm 39, and is incident on the half mirror 40. The light incident on the half mirror 40 is diverted upward at right angle, is incident on the objective lens 42, and is applied to the inspection surface of the object under inspection M. The image obtained by the reflection of this light at the inspection surface of the object under inspection M is enlarged by the objective lens 42, then travels through the half mirror 40, and is imaged by the imaging lens 41 on the image capturing means 17. The operation of the diaphragm 39, the conversion from optical image data to electrical image data, and the movement of the object under inspection M by the stage 5 are the same as those described above.

Thus inspection by transmissive light and inspection by reflective light are performed. Here, even if the dimension of the object under inspection is not more than the wavelength of inspection light and the resolution is decreased, the diffracted light can be collected, background light not contributing to the contrast can be blocked, and hence high-resolution inspection can be performed.

Next, a description is given of inspection where an optimal irradiation condition is specified for each inspection area of the object under inspection M.

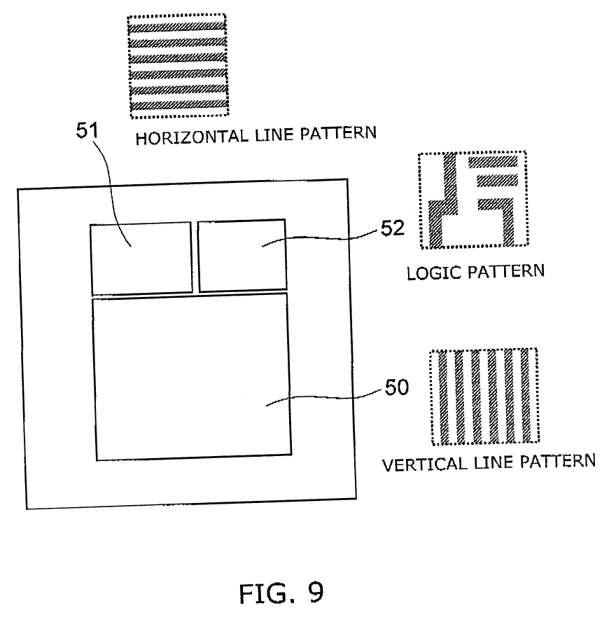

FIG. 9 is a schematic diagram for illustrating inspection where an optimal irradiation condition is specified for each inspection area.

As shown in FIG. 9, for an inspection area 50 having a pattern of vertical lines with a constant pitch such as a pattern of cell regions in a DRAM (dynamic random access memory) and NAND flash memory requiring high-resolution inspection, inspection using linearly polarized light is performed where the azimuthal angle of the polarization plane is matched with the direction of the pattern. It is also possible to perform inspection using an annular diaphragm having a prescribed radius and area of opening.

Similarly, for an inspection area 51 having a pattern of horizontal lines with a constant pitch, inspection using linearly polarized light is performed where the azimuthal angle of the polarization plane is adapted to the direction of the pattern. It is also possible to perform inspection using an annular diaphragm having a prescribed radius and area of opening.

For an inspection area 52 having an irregular pattern (e.g., a logic pattern), the linearly polarized light is converted to circularly polarized light, which is used for inspection. It is also possible to perform inspection using a diaphragm having an opening at its center in addition to an annular opening.

It is also possible to use both a phase difference plate and a diaphragm for inspection in which the type of polarization is appropriately combined with an annular opening.

Thus, according to the invention, an optimal irradiation condition is specified in the condition for each inspection area such as the direction and dimension of the pattern.

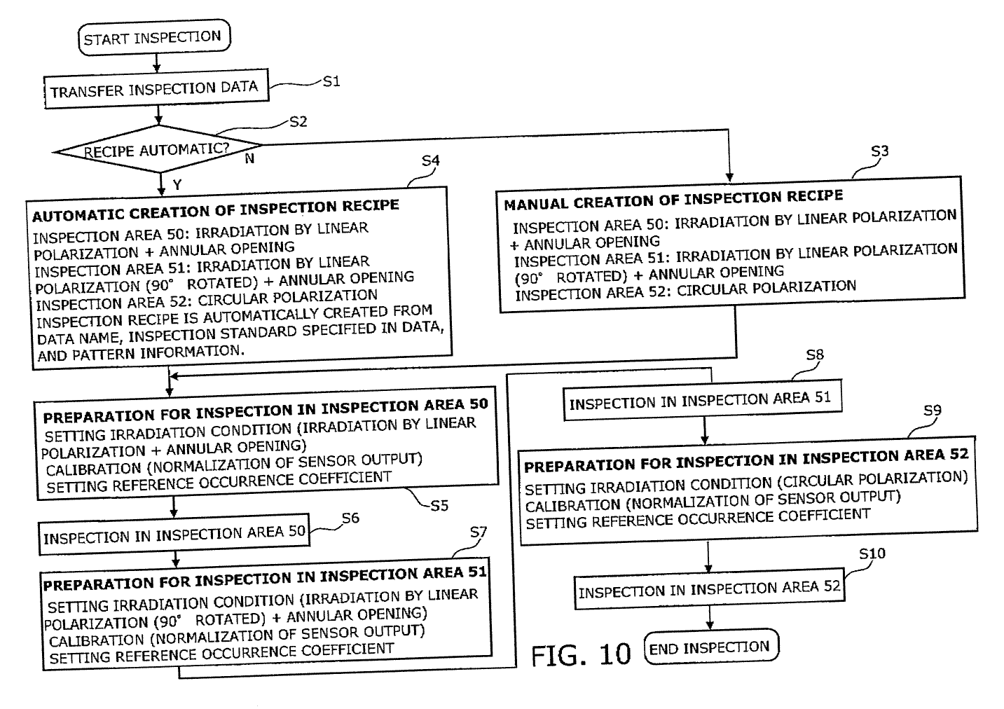

FIG. 10 is a flow chart for illustrating the inspection procedure.

As shown in FIG. 10, the method of creating an inspection recipe depends on whether the irradiation condition can be automatically specified from the inspection data. If any inspection standard and pattern information (information on whether the pattern is composed of lines having a constant pitch, and the direction and pitch dimension of the pattern) are specified in the inspection data to allow automatic determination and configuration of inspection and irradiation condition for each inspection area, then an inspection recipe can be automatically created using a computer. However, if it is impossible to recognize such pattern information from the inspection data and to automatically create an inspection recipe, creating an inspection recipe requires a human operator to input necessary information.

After the inspection recipe is created, the irradiation condition is specified for each inspection area in accordance with the inspection recipe, and inspection is performed under the specified irradiation condition.

Although not necessary, it is more preferable to perform calibration for setting the sensor output level of the image capturing means 17 to a particular level, and to specify the reference occurrence coefficient required for creating reference data in the case of die-to-database inspection.

Here, the reference occurrence coefficient is briefly described. The reference occurrence coefficient is a coefficient for correcting the error occurring between the pattern data on the database and the data of the imaged pattern.

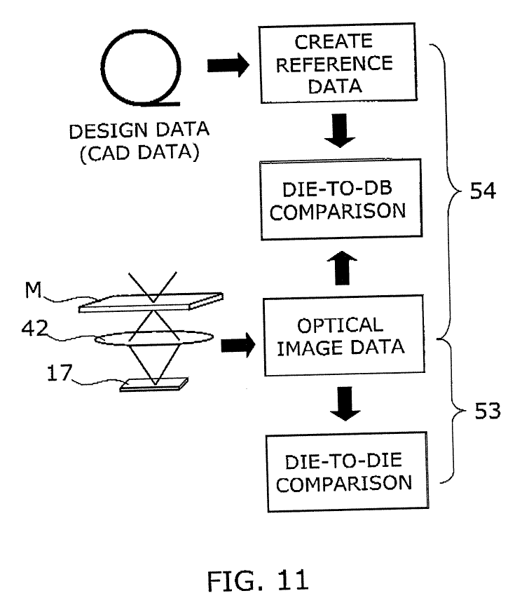

FIG. 11 is a schematic diagram for illustrating the method of matching inspection data.

As shown in FIG. 11, there are two types of inspection. In die-to-database inspection, the optical image data of the pattern obtained by the image capturing means 17 is compared with the reference data created from CAD data on a database, i.e., the design data of the object under inspection M. On the other hand, in die-to-die inspection, the optical image data of the pattern obtained by the image capturing means 17 is compared with the optical image data of the pattern of the object under inspection M obtained from a repeated portion of the same pattern. Die-to-die inspection produces no error between data because comparison is made between the captured optical image data. However, die-to-database inspection may involve intrinsic errors between data because comparison is made between the captured optical image data and the reference data created from design data. The reference occurrence coefficient serves to correct such errors so that the optical image data can be correctly compared with the reference data.

Inspection is performed in the following procedure inspection data is transferred from a database, not shown (step S1). A determination is made as to the possibility of automatically creating an inspection recipe (step S2). When automatic creation is not possible, a human operator creates an inspection recipe by inputting necessary information (manual creation) (step S3). When automatic creation is possible, an inspection recipe is automatically created using a computer (step S4). Here, the inspection recipe includes the irradiation condition (linear/circular polarization, the azimuthal angle of linearly polarized light, and the position and area of opening of the diaphragm) in the inspection area. Specifically, the inspection recipe can include the adjustment value for the rotation angle of the phase difference plate and/or the position and area of opening of the diaphragm. The inspection recipe can include conditions for a plurality of inspection areas. Preparations for inspection in the inspection area 50 are made, including setting the irradiation condition, performing calibration, and calculating the reference occurrence coefficient (step S5). The stage 5 is used to move the object under inspection M to the position for inspection in the inspection area 50, and inspection for the inspection area 50 is performed (step S6). Preparations for inspection in the inspection area 51 are made, including setting the irradiation condition, performing calibration, and calculating the reference occurrence coefficient (step S7) The stage 5 is used to move the object under inspection M to the position for inspection in the inspection area 51, and inspection for the inspection area 51 is performed (step 58). Preparations for inspection in the inspection area 52 are made, including setting the irradiation condition, performing calibration, and calculating the reference occurrence coefficient (step S9). The stage 5 is used to move the object under inspection M to the position for inspection in the inspection area 52, and inspection for the inspection area 52 is performed (step S10). When inspection is finished with all the inspection areas, the inspection is completed. For convenience of illustration, the number of inspection areas is assumed to be three. However, it is not limited thereto, but may be suitably changed.

Next, a description is given of a third embodiment of the invention, which relates to a method for manufacturing a semiconductor device. This method for manufacturing a semiconductor device is based on the above method for inspecting a pattern according to the invention, and includes repeating the step of forming a pattern on a substrate (wafer) surface by deposition, resist coating, exposure, development, etching, and resist removal, the inspection step based on the method for inspecting a pattern according to the invention, and the steps of cleaning, heat treatment, doping, diffusion, and planarization. The steps other than the inspection step based on the above method for inspecting a pattern according to the invention can use known techniques for the respective steps, and hence are not further described.

The embodiments of the invention have been described with reference to the examples. However, the invention is not limited to these examples.

Any variations of the above examples by those skilled in the art are also encompassed within the scope of the invention as long as they include the features of the invention. For example, in the inspection apparatus, the shape, arrangement, and number of parts of the floodlight system for inspection by transmissive light, the floodlight system for inspection by reflective light, the inspection optical system for capturing an image of an object under inspection, and the stage for mounting and moving the object under inspection are not limited to those illustratively described above.

Furthermore, the object under inspection may be transparent, opaque, or translucent, and may be made of any materials such as glass and silicon. For convenience of illustration, the object under inspection is described with reference to a mask used in the exposure process for a semiconductor device, a glass substrate used as a display panel in a liquid crystal display device, and a substrate (wafer) for a semiconductor device. However, applications of the object under inspection are not limited thereto.

1. An apparatus for inspecting a pattern, comprising:
at least one of a first floodlight system for inspection by transmissive light and a second floodlight system for inspection by reflective light;
an inspection optical system for capturing an image of the pattern on an object under inspection; and
a stage for mounting and moving the object under inspection,
the one of the first floodlight system and the second floodlight system including a diffracted light control means for enhancing light diffracted by the pattern.

2. The apparatus for inspecting a pattern according to claim 1, wherein the diffracted light control means includes a phase difference plate.

3. The apparatus for inspecting a pattern according to claim 2, wherein the phase difference plate is one of half-wavelength plate and a quarter-wavelength plate.

4. The apparatus for inspecting a pattern according to claim 3, wherein the half-wavelength plate varies an azimuthal angle of a polarization plane of linearly polarized light.

5. The apparatus for inspecting a pattern according to claim 3, wherein the quarter-wavelength plate converts among linear, circular, and elliptic polarization.

6. The apparatus for inspecting a pattern according to claim 2, wherein the diffracted light control means further includes a rotation means for rotating the phase difference plate with an optical path serving as a rotation axis.

7. The apparatus for inspecting a pattern according to claim 2, wherein the diffracted light control means further includes a diaphragm.

8. The apparatus for inspecting a pattern according to claim 7, wherein the diaphragm is provided at least one of a pupil plane of an objective lens and a conjugate position of the pupil plane.

9. The apparatus for inspecting a pattern according to claim 7, wherein the diaphragm makes a diffraction angle of a zeroth order diffracted light and a diffraction angle of a n-th order diffracted light same.

10. The apparatus for inspecting a pattern according to claim 7, wherein the diaphragm has an annular opening.

11. The apparatus for inspecting a pattern according to claim 7, wherein a radius of the opening is equal to a value of incident light.

12. The apparatus for inspecting a pattern according to claim 7, wherein a radius of the opening is equal to a ratio of a numerical aperture of a transmissive light source to a numerical aperture of an objective lens.

13. The apparatus for inspecting a pattern according to claim 7, wherein the diffracted light control means further includes a diaphragm adjustment means for varying at least one of a position and an area of the opening.

14. The apparatus for inspecting a pattern according to claim 13, wherein the diaphragm adjustment means is a plate-like member which can be slid on a surface of the diaphragm.

15. The apparatus for inspecting a pattern according to claim 13, wherein the diaphragm adjustment means can select one from a number of diaphragms having different radiuses of different areas of opening.

16. A method for inspecting a pattern by capturing an image of the pattern on an object under inspection, the method comprising:
performing inspection by setting an irradiation condition of the diffracted light control means so as to enhance light diffracted by the pattern.

17. The method for inspecting a pattern according to claim 16, further comprising:
transferring inspection data including information on the pattern; and
creating an inspection recipe including the irradiation condition by using the inspection data.

18. The method for inspecting a pattern according to claim 16, wherein
the diffracted light control means includes a phase difference plate and a diaphragm, and
the irradiation condition includes at least one of the rotation angle of the phase difference plate and the position and the area of an opening of the diaphragm.

19. The method for inspecting a pattern according to claim 17, wherein the inspection recipe includes the irradiation condition for a plurality of inspection areas.

20. A method for manufacturing a semiconductor device, comprising:
forming a pattern on a substrate surface; and
inspecting the pattern using the method for inspecting the pattern by capturing an image of the pattern, the method including:
performing inspection by setting an irradiation condition of the diffracted light control means so as to enhance light diffracted by the pattern.
